(19) United States
(12) Patent Application Publication
(10) Pub. No.: US 2006/0167899 A1
(43) Pub. Date: Jul. 27, 2006

(54) Meta-data generating apparatus

(75) Inventors: Toshinori Nagahashi, Tatsuno (JP); Naoki Kayahara, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/334,619

(22) Filed: Jan. 18, 2006

(30) Foreign Application Priority Data
Jan. 21, 2005 (JP) 2005-013693

(51) Int. Cl. G06F 17/30

(52) U.S. Cl. 707/10

(57) ABSTRACT

A meta-data generating apparatus includes a personal contents information loading unit which loads personal contents information, a text extracting unit which extracts text from other contents information relating to the personal contents information loaded by the personal contents information loading unit, and a meta-data generating unit which generates, on the basis of the text extracted by the text extracting unit, retrieval meta-data for the personal contents information loaded by the personal contents information loading unit.

### BACKGROUND

1. Technical Field

The present invention relates to a meta-data generating apparatus which can readily generate retrieval meta-data used when personal contents composed of static image data and dynamic image data that have been created by an individual are retrieved.

2. Related Art

Recently, by the spread of a digital camera and a mobile phone with a camera, it is becoming very easy to store large amounts of picture and image data picked up, as personal contents, in a memory unit in a personal computer or a memory medium such as a compact disk, a digital video disc, or the like. Thus, it is necessary and essential to add meta-data in order to retrieve efficiently the personal contents including the large amounts of image and picture data.

In an image/picture of a digital camera and a digital video, picked-up date and time are automatically stored as meta-data. However, this is not enough on efficient retrieval. Further, though systems that create meta-data, such as Dublin Core and MPEG-7 are also equipped, work of creating and inputting the meta-data on the basis of these systems requires skill, and it is difficult for a general user that is not a specialist to create the meta-data.

An information processing method, an information processing device and a memory medium, as disclosed in JP-A-2003-303210 (Page 1, and FIGS. 1, 13) have been known, in which there are provided an event memory part capable of storing plural event information including at least data relating to time such as schedule data, and an information memory part capable of storing target data of image data having attached information (event information) including at least information relating to time; an event information relation judging part judges absence and presence of the relation between the event and the target data on the basis of the event information and the attached information; and its judgment result is displayed on an event display part as information perceivably indicating the target data.

However, in the related art disclosed in JP-A-2003-303210, it is necessary to prepare the event information such as the schedule data, and date and time of this event information must be maintained with high reliability, which is onerous. This onerousness comes to an unsolved problem. Further, when the event information is not prepared, there is also an unsolved problem that the retrieval cannot be performed.

### SUMMARY

An advantage of some aspects of the invention is to provide a meta-data generating apparatus which can readily generate retrieval meta-data that is high in compatibility with the personal contents and can perform readily the retrieval.

A meta-data generating apparatus according to a first aspect of the invention includes a personal contents information loading unit which loads personal contents information, a text extracting unit which extracts text from other contents information relating to the personal contents information loaded by the personal contents information loading unit, and a meta-data generating unit which generates, on the basis of the text extracted by the text extracting unit, retrieval meta-data for the personal contents information loaded by the personal contents information loading unit.

According to the first aspect of the invention, the personal contents information loading unit loads the personal contents information composed of static image data and dynamic image data picked up by a digital camera or a digital video. On the other hand, the text extracting unit extracts the text from other contents information relating to the personal contents information, for example, a homepage in the Internet and a printing on which an event is printed, and the retrieval meta-data is generated on the basis of the extracted text. Hereby, the retrieval meta-data that facilitates the retrieval for the personal contents information can be automatically generated readily.

Further, a meta-data generating apparatus according to a second aspect of the invention is characterized in that: in the first aspect, the meta-data generating unit includes a keyword selection unit which selects a keyword from the text extracted by the text extracting unit, and the meta-data generating unit generates, on the basis of the keyword selected by the keyword selection unit, the retrieval meta-data for the personal contents information loaded by the personal contents information loading unit.

According to the second aspect of the invention, the keyword selection unit selects a keyword from the text extracted by the text extracting unit, and the meta-data generating unit generates, on the basis of the selected keyword, the retrieval meta-data for the personal contents information. Therefore, the retrieval meta-data most suited to the personal contents information can be generated exactly and readily.

Further, a meta-data generating apparatus according to a third aspect of the invention is characterized in that: in the second aspect, the keyword selection unit is so constituted as to select characteristic character data in the text as a keyword.

According to the third aspect of the invention, since the characteristic character data such as a header or a bold character in the text is selected as the keyword, the keyword that indicates a matter shortly and directly can be selected exactly and readily.

Further, a meta-data generating apparatus according to a fourth aspect of the invention is characterized in that: in the third aspect, the character data has a characteristic font, compared with other character data included in the text.

According to the fourth aspect of the invention, the character data that is more noticeable in font size, font color, font type, and font attribute than other character data can be used as the keyword, and the keyword that indicates a matter shortly and directly can be selected exactly and readily.

Further, a meta-data generating apparatus according to a fifth aspect of the invention is characterized in that: in any one of the second to fourth aspects, the keyword selection unit has a word division unit which divides text data into words and extracts the words; and the keyword selection unit selects as the keyword the word selected on the basis of information of parts of speech of the words extracted by the word division unit.

According to the fifth aspect of the invention, the text data is divided into the words and their words are extracted by the word division unit, and the words selected on the basis of information of parts of speech of the words, for example, on the basis of proper nouns, are selected as keywords. Therefore, words except the words that cannot be adopted as the retrieval meta-data, for example, words except conjunctions and prepositions can be selected as the keyword, so that the keywords most suited to the personal contents information can be selected.

Further, a meta-data generating apparatus according to a sixth aspect of the invention is characterized in that: in any one of the second to fifth aspects, the keyword selection unit includes a keyword memory unit that stores the predetermined keyword, and selects, from the text extracted by the text extracting unit, a word that coincides with the keyword stored in the keyword memory unit, as a keyword.

According to this sixth aspect of the invention, from the text extracted by the text extracting unit with the predetermined keywords stored in the keyword memory unit as a dictionary, the word that coincides with the keyword stored in the keyword memory unit is selected as a keyword. Therefore, only the keyword by which more efficient retrieval can be performed can be extracted, so that the keyword most suited to the personal contents information can be selected.

Further, a meta-data generating apparatus according to a seventh aspect of the invention is characterized in that: in the sixth aspect, the keyword memory unit updates the stored keyword by means of any one or a plurality of digital broadcasting radio waves, a network, and a memory medium.

According to this seventh aspect of the invention, since the keyword stored in the keyword memory unit is updated by a keyword transmitted by means of the digital broadcasting radio waves or the network, or by a keyword stored in the memory medium, the optimum keyword can be always secured.

Furthermore, a meta-data generating apparatus according to an eighth aspect of the invention is characterized in that: in any one of the first to seventh aspects, the text extracting unit includes at least an image reading unit which reads a printing on which text is printed, an area identification unit which identifies a specified area from the image data read by the image reading unit, and a character recognition unit which character-recognizes the image data in the specified area identified by the area identification unit.

According to this eighth aspect of the invention, an area identification mark is given to a word in a sentence printed on the printing, which a user wants to extract in order to distinguish the word from other words. Hereby, this printing is read by the image reading unit as the image data, the area to which the area identification mark is given is extracted from this image data, words included in the extracted areas are character-recognized by the character recognition unit thereby to be extracted, a keyword is selected from the extracted words, and retrieval meta-data for the personal contents information is formed on the basis of the selected keyword. Therefore, the word specified by the user from the printing can be generated as retrieval meta-data.

Furthermore, a meta-data generating apparatus according to a ninth aspect of the invention is characterized in that in any one of the first to seventh aspects, the text extracting unit includes at least an image reading unit which reads a printing on which text is printed, a character recognition unit which character-recognizes the image data read by the image reading unit, and a word division unit which divides the characters recognized by the character recognition unit into words and extracts the words.

According to this ninth aspect of the invention, the image data read by the image reading unit is character-recognized by the character recognition unit and converted into text data. Since this text data is divided into words by the word division unit, the words can be extracted from an arbitrary printing.

Further, a meta-data generating apparatus according to a tenth aspect of the invention is characterized in that in any one of the first to seventh aspects, the text extracting unit includes at least an image reading unit which reads a printing on which text is printed, an area identification unit which identifies a specified area from the image data read by the image reading unit, a character recognition unit which character-recognizes the image data in the specified area identified by the area identification unit, and a word division unit which divides the characters recognized by the character recognition unit into words and extracts the words.

According to this tenth aspect of the invention, the image data in the specified area is character-recognized by the character recognition unit thereby to extract the text data, and this text data is divided into words by the word division unit thereby to extract the words. Therefore, it is possible to readily extract the word from the image data in an arbitrary area such as an area surrounded by a frame such as a header in spite of the specified area formed by the user.

Further, a meta-data generating apparatus according to an eleventh aspect of the invention is characterized in that in the first or second aspect, the text extracting unit includes at least a contents information collection unit which collects contents information through a network from contents information providing means, and a word division unit which extracts text from the contents information collected by the contents information collection unit, and divides the extracted text into words to extract the words.

According to the eleventh aspect of the invention, the contents information is collected from the contents providing means such as a homepage or an electronic mail, and the collected contents information is divided into words thereby to extract the words. Therefore, by specifying, for example, a news site of each area of a newspaper publishing company, event information of its date can be collected together with time information.

Further, a meta-data generating apparatus according to a twelfth aspect of the invention is characterized in that in the eleventh aspect, the keyword selection unit includes a comparison contents information collection unit which collects comparison contents information from other plural contents information providing means than the contents information providing means of the text extracting unit; a word division unit which divides the contents information collected by the comparison contents information collection unit into words to extract comparison words; and an important word judging unit which compares the comparison words extracted by the word division unit with the texts inputted from the text extracting unit, and judges whether the word inputted from the text extracting unit is an important word as a keyword or not.

According to the twelfth aspect of the invention, in case that the text extracting unit is so constituted as to collect the contents information from the contents information providing means, since the number of the extracted words becomes immense, the comparison contents information is collected from other plural contents information providing means that are different from the corresponding contents information providing means, the collected comparison contents information is divided by the word division unit into words thereby to extract the comparison words, the extracted comparison words are compared with the words extracted by the text extracting unit, and whether the words extracted from the text extracting unit are the important words as the keyword or not is judged. Hereby, the keyword suited to the personal contents information can be selected.

Furthermore, a meta-data generating apparatus according to a thirteenth aspect of the invention is characterized in that in the twelfth aspect, the important word judging unit judges the word which is inputted from the text extracting unit and high in appearance frequency, and the comparison word which is low in appearance frequency to be important words, and extracts these words as keywords.

According to the thirteenth aspect of the invention, when the important word is extracted, the word which is inputted from the text extracting unit and high in appearance frequency, and the comparison word which is low in appearance frequency are high in possibility of new words. For example, in case the text extracting unit extracts words from local and nationwide contents information, a word obtained by removing words that appear in the nationwide contents information from words extracted from the local contents information is selected as a keyword, whereby the keyword most suited to the personal contents information can be selected.

### BRIEF DESCRIPTION OF THE DRAWINGS

The invention will be described with reference to the accompanying drawings, wherein like numbers reference like elements.

FIG. 1 is a block diagram showing one embodiment of the invention.

FIG. 2 is a function block diagram of a central processing unit.

FIG. 3 is a flowchart showing one example of a personal contents information loading processing procedure which is executed by the central processing unit.

FIG. 4 is an explanatory diagram showing a memory area of a memory card of a digital camera.

FIG. 5 is a flowchart showing one example of a word extraction processing procedure which is executed by the central processing unit.

FIG. 6 is a flowchart showing one example of a meta-data generating processing procedure which is executed by the central processing unit.

FIG. 7 is an explanatory diagram showing one example of retrieval meta-data added to personal contents information.

FIG. 8 is a block diagram showing a second embodiment of the invention.

FIG. 9 is a function block diagram of a central processing unit.

FIG. 10 is an explanatory diagram showing a printing.

FIG. 11 is an explanatory diagram showing a state in which an area identifying mark is given in the printing.

FIG. 12 is a flowchart showing one example of a meta-data generating processing procedure which is executed by the central processing unit.

FIGS. 13A and 13B are diagrams for explaining cutting processing of the area identifying mark.

FIG. 14 is an explanatory diagram showing one example of meta-data added to personal contents information.

### DESCRIPTION OF EXEMPLARY EMBODIMENTS

Embodiments of the invention will be described below with reference to drawings.

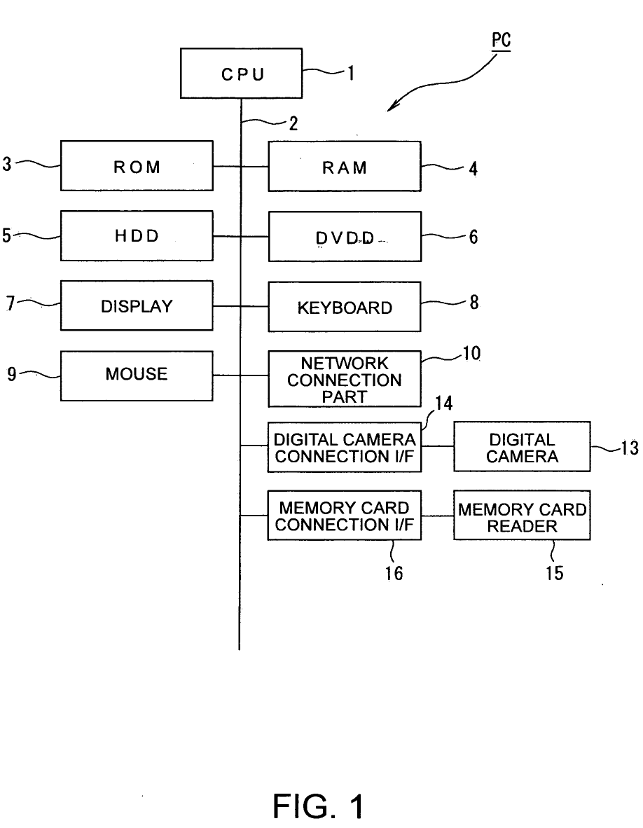

FIG. 1 is a block diagram showing a first embodiment of the invention. In FIG. 1, reference character PC is an information processing apparatus composed of a personal computer, a server, and the like. This information processing apparatus PC has a central processing unit (CPU) 1, to which a ROM 3 that stores a program executed by the central processing unit 1, a RAM 4 that stores data necessary for processing executed by the central processing unit 1, a hard disc drive (HDD) 5 that stores an application program, and personal and general contents information described later, a DVD drive (DVDD) 6 that performs writing and loading for a digital versatile disc (DVD), a display 7 that displays data, and a keyboard 8 and a mouse 9 which are used in order to input data are connected through a system bus 2.

Further, to the system bus 2, a network connection part 10 that connects to a network such as the Internet, a digital camera connection interface 14 that connects a digital camera 13 functioning as a personal contents information creating unit, and a memory card interface 6 that connects various memory cards 15 are connected.

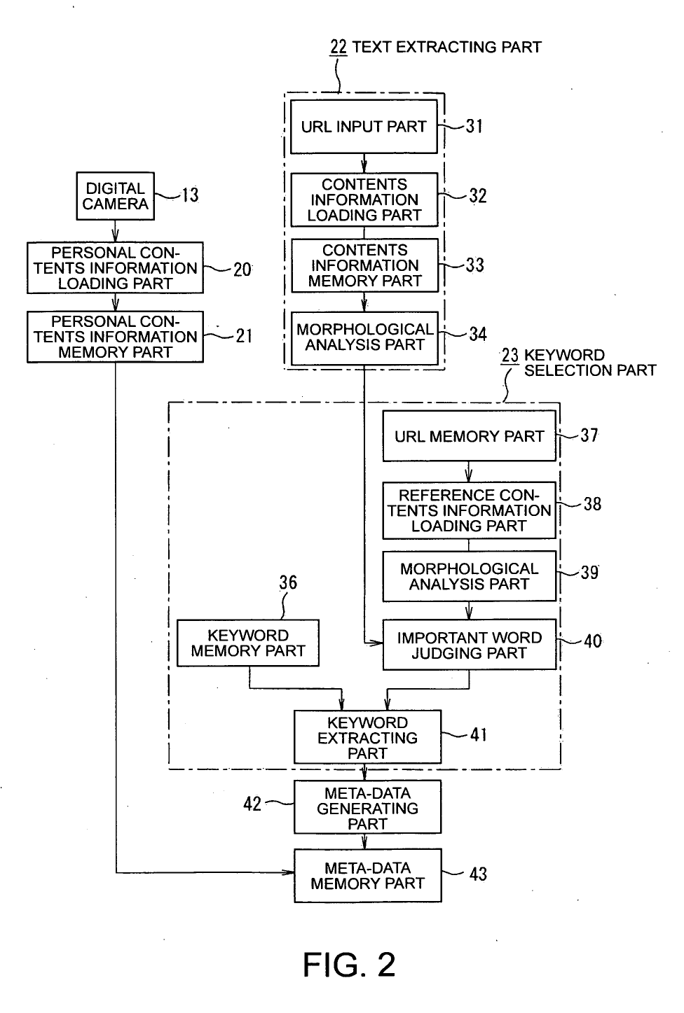

The central processing unit 1, in case that it is shown by a function block diagram, includes, as shown in FIG. 2, a personal contents information loading part 20 which loads personal contents information composed of image data and pick-up meta-data described later from the digital camera 13, a personal contents information memory part 21 which stores the personal contents information load by this personal contents information loading part 20, a text extracting part 22 which collects a base contents information for generating retrieval meta-data that facilitates retrieval of personal contents information, thereby to extract a word such as proper noun, a keyword selection part 23 which selects a keyword on the basis of the word extracted by this text extracting part 22, a meta-data generating part 42 which converts the keyword selected by this keyword selection part 23 into retrieval meta-data, and a meta-data memory part 43 which adds the retrieval meta-data generated by this meta-data generating part 42 to the meta-data of the personal contents information stored in the personal contents information memory part 21 and stores the added data.

The text extracting part 22 includes a URL input part 31, a contents information loading part 32, a contents information memory part 33, and a morphological analysis part 34. The URL input part 31 inputs a URL (Uniform Resource Locator) for accessing through the Internet to a homepage such as a news site in a newspaper publishing company, which becomes base data for generating retrieval meta-data that facilitates retrieval of personal contents information. The contents information loading part 32 loads contents information from the homepage accessed on the basis of the URL inputted by this URL input part 31, the contents information memory part 33 stores the contents information load by this contents information loading part 32, and the morphological analysis part 34 functions as a work division unit which morphology-analyzes the contents information stored in the this contents information memory part 33 to extract a word.

Further, the keyword selection part 23 includes a keyword memory part 36 which stores many keywords that become a keyword dictionary; a URL memory part 37 which stores plural URL's that specify the previously set reference homepages; a reference contents information loading part 38 which loads reference contents information from a homepage accessed on the basis of the URL stored in this URL memory part 37; a morphological analysis part 39 as a work division unit which morphology-analyzes the reference contents information load by this reference contents information loading part 38 to extract words; an important word judging part 40 which judges an important word on the basis of the word inputted from the text extracting part 22 and the word of the reference contents information outputted from the morphological analysis part 39; and a keyword extracting part 41 which compares the important word judged by the important word judging part 40 with the keyword stored in the keyword memory part 36 and extracts the important word that coincides with the keyword stored in the keyword memory part 36 as a keyword. Further, the keywords stored in the keyword memory part 36 are updated regularly or in the desired time in order through a communication medium such as digital broadcasting radio waves, the Internet, or the like. Further, on the basis of a memory medium such as a flexible magnetic disc or a CD which stores update-to-date keywords, the keywords may be updated.

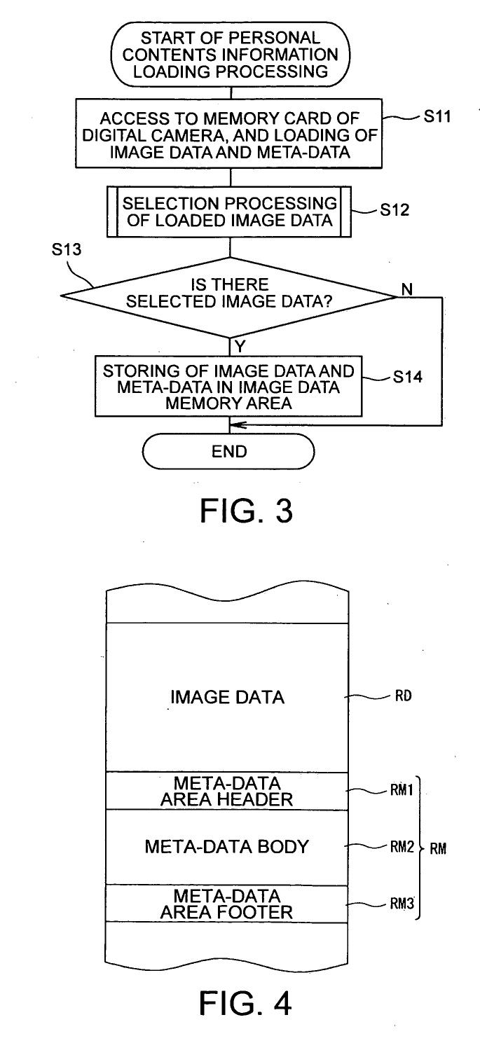

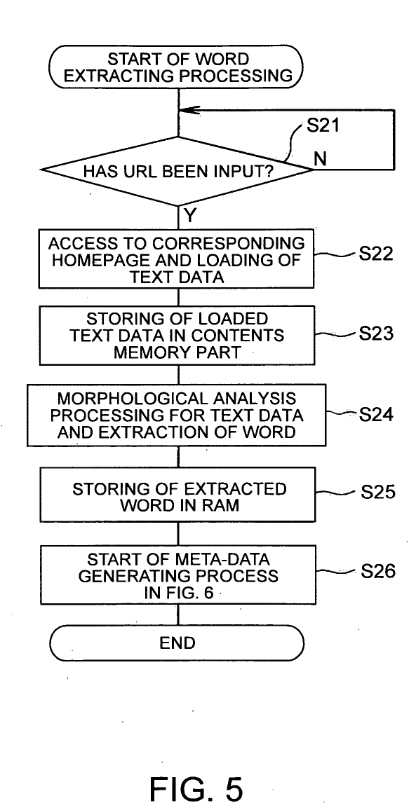

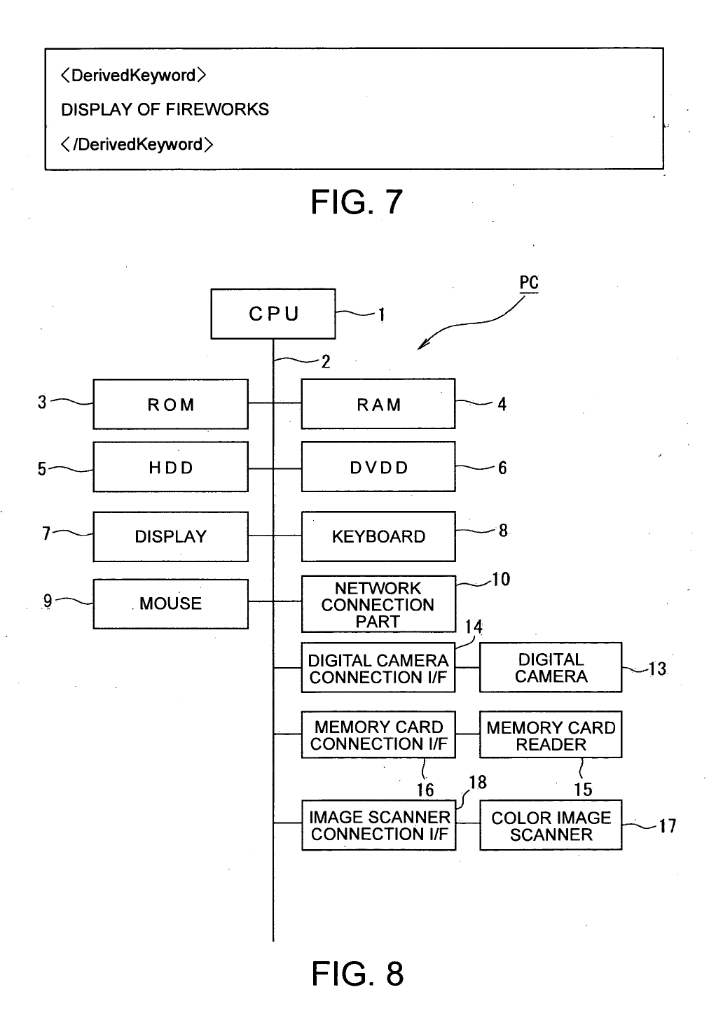

The central processing unit 1 executes a personal contents information loading processing shown in FIG. 3 which loads static image data from the digital camera 13, a word extraction processing shown in FIG. 5 which loads contents information that becomes base date for generating meta-data that facilitates the retrieval of the personal contents information thereby to extract words, and a meta-data generating processing shown in FIG. 7, which extracts an important word from the words extracted by the word extracting processing to select a keyword, and converts the selected keyword into retrieval meta-data to generate the retrieval meta-data.

The personal contents information loading processing is executed when the digital camera 13 is connected to the digital camera connection interface 12. As shown in FIG. 3, firstly, in a step S11, access to a memory card which stores, with association, picked-up image data and its meta-data that are included in the digital camera 13 is performed, whereby the image data and the meta-data stored in this memory card are load in order.

The image data is stored in the card memory, as shown in FIG. 4, in a coupling type of a data recording area RD for, for example, JPEG (Joint Photographic Experts Group) data in which binary image data picked up by the digital camera 13 is compressed, and a pick-up meta-data recording area RM which follows to this data recording area RD and stores meta-data that is written as XML (Extensible Markup Language) data. The meta-data recorded in the pick-up meta-data recording area RM is composed of a meta-data area header RM1, a meta-data body RM2, and a meta-data area footer RM3. In the meta-data area header RM1 and the meta-data area footer RM3, in order to properly recognize whether the meta-data is coupled to the image data or not, identification information and size information in the pick-up meta-data area RM are recorded. In the meta-data body RM2, pick-up information of the picked-up image, for example, date and time information, a shutter speed, and an iris are recorded in an XML file type.

Thus, by forming the meta-data recording area RM next to the image data recording area RD, the meta-data can be registered without affecting other applications. Namely, since the information in a header portion of the image data has not changed even in connection of the meta-data, the image data can be reproduced by a general browser.

Next, the procedure proceeds to a step S12, in which the loaded image data is displayed on the display 7, and selection processing of selecting image data that a user wants to load is performed. Next, in a step S13, whether the image data selected by the selection processing exists or not is judged. In case that the selected image data does not exist, the loading processing ends, and in case that the selected image data exist, the procedure proceeds to a step S14. In the step S14, the selected image data and meta-data belonging to this image data are stored in the image data memory area as the specified personal contents information memory area of the hard disk drive 5, and thereafter the image data loading processing ends.

Further, the word extraction processing, as shown in FIG. 5, firstly judges, in a step S21, whether the URL input part 31 has inputted a URL of, for example, a news site by a newspaper publishing company or not. When the URL has not been input, the word extraction processing waits till the URL is inputted. When the URL has been input, the procedure proceeds to a step S22.

In this step S22, the corresponding homepage is accessed on the basis of the URL, text data written into the corresponding homepage is loaded, and the procedure proceeds to a step S23. In the step S23, the loaded text data is stored in the contents information memory part formed in the hard disc 5, and thereafter the procedure proceeds to a step S24.

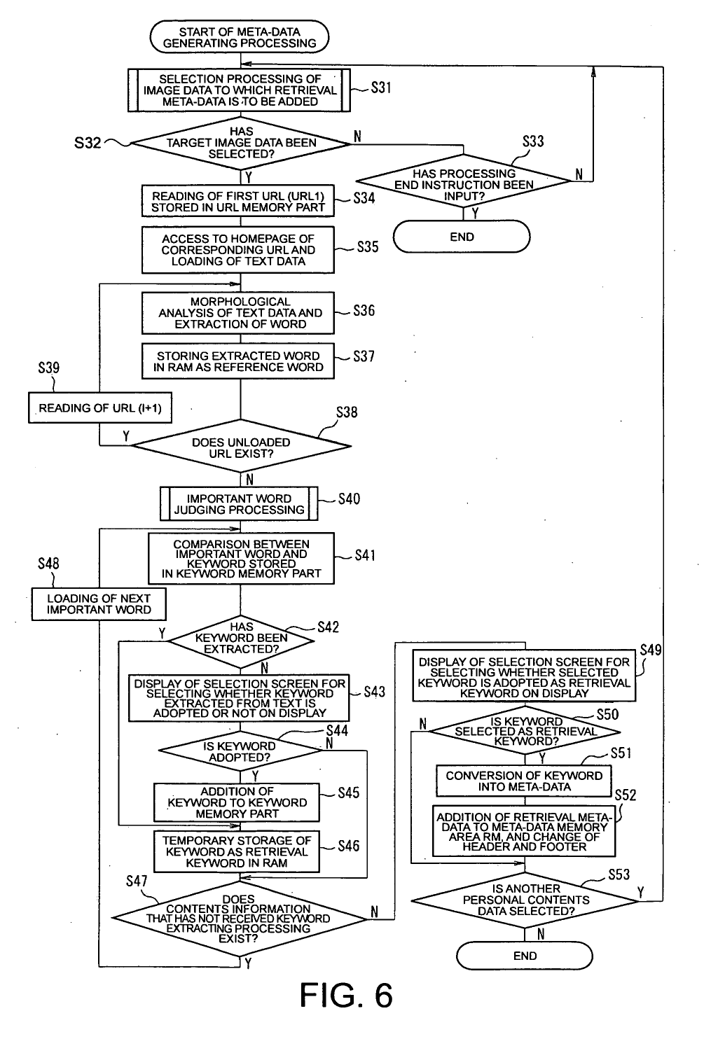

In this step S24, morphological analysis processing is performed on the text data stored in the contents information memory part thereby to extract words, and the procedure proceeds to a next step S25. In the step S25, the extracted words are temporarily stored in the RAM 4, and the procedure proceeds to a next step S26. In the step S26, meta-data generating processing shown in FIG. 6 starts and the word extracting processing ends.

Further, the meta-data generating processing, as shown in FIG. 6, is started in completion time of the word extracting processing. Firstly, in a step S31, image data to which the retrieval meta-data that facilitates the retrieval of image data is to be added is loaded from the image data memory area of the hard disc drive 5, and image data selection processing that displays the loaded image data on the display 7 is performed. Next, in a step S32, whether the image data to which the retrieval meta-data is to be added has been selected or not in the image data selection processing is judged. When the image data has not been selected, the procedure proceeds to a step S33, and whether there is an instruction of processing completion by selection of a processing completion button for completing the meta-data generating processing or not is judged. When there is the instruction of processing completion, the meta-data generating processing ends as it is. When there is not the instruction of processing completion, the procedure returns to the step S31.

On the other, when the judgment in the step S32 results in that the selected image data exists, the procedure proceeds to a step S34. In the step S34, a first one of URL1 to URLn in, for example, news sites of plural nationwide newspaper publishing companies, which are previously stored in the URL memory part 37, that is, URL1 is read out. Next, in a step S35, the corresponding homepage is accessed on the basis of the read-out URL 1, and text data described in the corresponding homepage is loaded. Next, in a step S36, morphological analysis processing is performed on the loaded text data to extract words that are, for example, proper nouns. Next, in a step S37, the extracted words are temporarily saved in the predetermined memory area of the RAM 4 as reference words and thereafter the procedure proceeds to a step S38.

In this step S38, whether the unloaded URL exists or not is judged. When the unloaded URL exists, the procedure proceeds to a step S39. In the step S39, a new URL value (i+1) is obtained by adding “1” to the present URL number URLi (i=1˜n), the corresponding URL (i+1) is read-out from the URL memory part 37, and the procedure returns to the step S35.

Further, when the judgment in the step S38 results in that regarding all the URL's, loading of the text data is completed, the procedure proceeds to a step S40, and important word judging processing that corresponds to processing by an important text extracting part is executed thereby to extract a keyword.

Here, in the important word judging processing, TFIDF (Term Frequency & Inverse Document Frequency) processing is performed thereby to calculate weight W of the word and extract an important word. The TFIDF is obtained as shown in the following expression (1) by the product of appearance frequency (TF) of the word extracted by the word extracting processing and the inverse of the text data number frequency in which its extracted word is used in the whole of the text data including the reference words. The larger the numerical value is, the more important its extracted word is. The TF is an index indicating that the word appearing frequently is important. The IDF is an index indicating that the word appearing in many document data is not important, that is, the word appearing in the specified document data is important, and the IDF has characteristic that its value becomes larger as the number of text data in which a word is used decreases. In order to simplify the description, a case where a homepage of a newspaper publishing company is used as contents information providing means will be given below as an example. Considering homepages of a nationwide newspaper and a local newspaper, the local newspaper that reports local information is closer, and it can be thought that: the local newspaper is more suited to extract words used as meta-data of personal contents; and frequency in which these words appear in the homepage of the nationwide newspaper is low.

Therefore, the value of TFIDF becomes small for words that appears frequently but appear in many text data (conjunctions, postpositional words functioning as an auxiliary to a main word, and the like), and words that appear in only the specified text data but are low in frequency in its text data, while the value of TFIDF becomes large for words appearing in only the specified document data with high frequency. It is possible to discriminate between the word described in the nationwide newspaper and the word described in the local newspaper by the TFIDF to judge the word described in the local newspaper as an important word.
W(t,d)=TF(t,d)×IDF(t) (1)
Herein, TF (t, d) represents frequency in which a word t appears in text data d, IDF (t) is log (D/DF(t)), DF (t) is frequency of the text data number in which the word t appears in the whole of text data, and D is all the text data number.

In case that URLᵢ (i=1˜m) is taken as the URL of the homepage, and an appearing word is taken as Tⱼ (j=1˜n), the following matrix Wᵢⱼ can be calculated by means of the expression (1).

TABLE 1

| | T₁ | T₂ | . . . | Tₘ |
|---|---|---|---|---|
| URL₁ | W₁₁ | W₁₂ | | W₁ₘ |
| URL₂ | W₂₁ | W₂₂ | | W₂ₘ |
| . . . | . . . | . . . | . . . | |
| URLₘ | Wₘ₁ | Wₘ₂ | | Wₘₘ |

In case that a homepage of a local newspaper is URLₘ, in order of large value of matrix elements Wₘ₁, Wₘ₂, . . . Wₘₘ, words Tⱼ may be extracted and judged to be important words.

Next, in a step S41, the important words are compared with the memory keywords stored in the keyword memory part 36, and the procedure proceeds to a step S42. In the step S42, whether the keyword that coincides with the important word exists or not is judged. When the keyword that coincides with the important word exists, the procedure jumps up to a step S46 described later. When the keyword that coincides with the important word does not exist, the procedure proceeds to a step S43. In the step S43, a selection screen for selecting whether the important word extracted from the text data is adopted as a keyword or not is displayed on the display 7, and the procedure proceeds to a step S44. In the step S44, whether the adoption as the keyword has been set or not is judged. When the adoption as the keyword is not selected, the procedure jumps up to a step S47 described later. When the adoption as the keyword is selected, the procedure proceeds to a step S45. In the S45, the adopted keyword is added to the keyword memory part, and the procedure proceeds to the step S46.

In the step S46, the extracted keyword is temporarily stored in the RAM 4 as a retrieval keyword, and the procedure proceeds to the step S47. In the step S47, whether the important word that has not received the keyword extracting processing yet exists or not is judged. In case that the important word that has not received the keyword extracting processing yet exists, the procedure proceeds to a step S48. In the step S48, the next important word is loaded and thereafter the procedure returns to the step S41. When the keyword extracting process is completed for all the extracted important words, the procedure proceeds to a step S49.

In this step S49, a selection screen for selection whether the selected keyword is adopted as retrieval keyword is displayed on the display 7, and the procedure proceeds to a step S50. In the step S50, whether the selected keyword is selected as the retrieval keyword is judged. When the selected keyword is not selected as the retrieval keyword, the procedure jumps to a step S53 described later. When the selected keyword is selected as the retrieval keyword, the procedure proceeds to the step S51. In the step S51, the retrieval keyword is converted into retrieval meta-data, and the procedure proceeds to a step S52. In the step S52, the converted retrieval meta-data is added to the meta-data memory area RM of the corresponding image data, the meta-data area header RM1 and the meta-data area footer RM3 are changed, and thereafter the procedure proceeds to the step S53.

In the step S53, whether another personal contents information is selected is judged. In case that another personal contents information is selected, the procedure returns to the step S31. In case that another personal contents information is not selected, the meta-data generating processing ends.

The processing in FIG. 3 corresponds to processing by the personal contents information loading unit, and the processing in FIG. 5 corresponds to processing by the text extracting unit, in which the processing in the steps S21 to S23 correspond to processing by the contents information collection unit, and the processing in the step S24 corresponds to processing by the word division unit. In the processing of FIG. 6, the processing in the steps S34 to S47 correspond to processing by the keyword extracting unit, the processing of the steps S34, S35, S38, and S39 of these steps correspond to processing by the reference contents information collecting unit, the processing in the step S37 corresponds to processing by the word division unit, the processing in the step S40 corresponds to processing by the important word judging unit, and the processing in the steps S49 to S52 correspond to processing by the meta-data generating unit.

Next, the operation in the first embodiment will be described.

Firstly, by means of the digital camera 13, a user takes a photograph of scenery or a person in, for example, a display of fireworks, and personal contents information composed of its bit map image data, and pick-up meta-data including pick-up date and time and pick-up data is stored a memory card of the digital camera 13.

Thereafter, the user takes the digital camera 13 home. In a state where the digital camera 13 is directly connected to the digital camera connection interface 14, or the memory card is pulled out from the digital camera 13 and attached to the memory card reader 15 connected to the memory card interface 16, the personal contents information loading processing shown in FIG. 3 is executed.

Hereby, the memory card is accessed to load each personal contents information stored in this memory card (step S11), each loaded personal contents information is displayed on the display 7 to perform the image data selection processing of selecting the necessary personal contents information (step S12), and the personal contents information composed of the image data selected by this image data selection processing and the pick-up meta-data is stored in the image data memory area as the specified personal contents information memory area of the hard disc drive 5 (step S14).

When or after the storage of this personal contents information in the hard disc drive 5 has been completed, in order to add retrieval meta-data for facilitating retrieval to the stored personal contents information, an icon displayed on the display 7 is clicked to execute the word extracting processing shown in FIG. 5.

In this word extracting processing, when a URL for specifying a news site of, for example, a local newspaper in which possibility capable of obtaining information relating to the personal contents information picked up by the user is high is inputted by the URL input part 31, a corresponding homepage of the URL is accessed and text data is loaded (step S22). The loaded text data is stored in the contents information memory part 33 (step S23).

The morphological analysis processing is performed on the stored text data thereby to extract words including proper nouns (step S24), and the extracted words are temporarily stored in the predetermined memory area of the RAM 4 (step S25). Next, the meta-data generating processing shown in FIG. 6 starts (step S26), and the word extracting processing ends. At this time, for example, in case that a header is “Display of Fireworks”, and an article of “There was a display of fireworks on Sumida River on O day in O month, and hundreds of thousands spectators collected. . . . ” is written, the extracted words are display of fireworks, Sumida River, O day O month, hundreds of thousands, spectators, . . . .

In the meta-data generating processing, firstly, the selection processing of selecting the personal contents information to which the retrieval meta-data is to be added is executed. In this selection processing, the personal contents information stored in the personal contents information memory area of the hard disc 5 are displayed on the display 7, and the desired personal contents information is selected from the displayed personal contents information (step S31). In this case, as the personal contents information, one image data may be selected, or the plural image data are collected in groups and the personal contents information may be selected in a group unit.

In case that the selection of the personal contents information is not performed, whether the processing end instruction of clicking the processing end button by the mouse has been input is judged (step S33). When the processing end instruction has been input, the meta-data generating processing ends as it is. When the processing end instruction has not been input, the procedure returns to the step S31 and the personal contents information selection processing is continued.

When the arbitrary personal contents information is selected in single or in a group unit in this meta personal contents information selection processing, the procedure proceeds from the step S32 to the step S34. From plural URL's for specifying the reference contents information stored in the URL memory part 31, for example, plural URL's that specify the news sites of the nationwide newspaper publishing companies, the first URL 1(URL 1) is loaded. Next, the homepage of the corresponding URL1 is accessed to load the text data (step S35). The morphological analysis processing is performed on the loaded text data to extract the words of proper nouns (step S36).

Next, the extracted words are temporarily stored in the predetermined memory area of the RAM 4 as the reference words, and next, whether there is an unloaded URL of the URL's stored in the URL memory part 37 or not is judged (step S38). In case that there is the unloaded URL, a new URL (=URL(i+1)) is calculated, and this new URL is read out from the URL memory part 37 (step S39). Thereafter, the procedure returns to the step S35, the text data of the corresponding homepage is loaded again, the morphological analysis processing is performed to extract reference words, and the reference words are temporarily stored in the RAM 4.

Upon completion of the word extraction regarding all the URL's stored in the URL memory part 37, the important word extracting processing is performed on the basis of the words extracted from the text data acquired from the homepage of the local news paper according to user's preference in the word extracting processing of FIG. 5, and the reference words extracted from the text data acquired from the reference URL homepage of the nationwide newspaper. The word in the words extracted from the text data acquired from the homepage of the local newspaper, which is high in appearance frequency, and the word in the words extracted from the text data acquired from the homepage of the nationwide newspaper, which is low in appearance frequency are extracted as important words (step S40). Therefore, the words which the nationwide newspaper treats as news are not extracted as the important words but the words which the local newspaper treats as news, which relate to the personal contents information picked up by the user are extracted as the important words. Namely, in the news site of the nationwide newspaper, fireworks on Sumida River are not treated as an article. However, in case that a serious matter has occurred on the Sumida River, an article on this matter and other nationwide important articles are reported in the nationwide newspaper (There is also an article that overlaps with the article which the local newspaper treats.). Therefore, since, of the words extracted by the word extracting processing in FIG. 5, “O day O month” and “Sumida River” are described also in the article of the nationwide newspaper, “Display of Fireworks” which the nationwide newspaper does not adopt as an article is extracted as the important word.

Whether the extracted important word coincides with the keyword stored in the keyword memory part 36 or not is judged. In case that the extracted important word coincides with the keyword stored in the keyword memory part 36, the extracted important word is temporarily stored as a retrieval keyword in the RAM 4. In case that the extracted important word does not coincide with the keyword stored in the keyword memory part 36, a selection screen for selecting whether the important word is adopted as a keyword or not is displayed on the display 7. When the important word is adopted as the keyword, it is additionally stored as the keyword in the keyword memory part 36 (step S45), and thereafter the corresponding important word is temporarily stored as the retrieval keyword in the RAM 4. When the important word is not adopted as the keyword, it is not stored in the keyword memory part 36 and the keyword setting processing for the next important word is performed.

When the keyword extracting processing for all the important words is completed, a selection screen for selecting whether the retrieval keywords temporarily stored in the RAM 4 are adopted as the retrieval keywords for the personal contents information or not is displayed on the display 7 (step S49). When the stored retrieval keywords have been selected as retrieved keywords, the selected retrieval keywords such as “Display of Fireworks” and “Sumida River” are converted into meta-data (step S51). This meta-data are added in the meta-data memory area RM of the corresponding personal contents information, and the meta-data area header and the meta-data area footer are changed (step S52). Next, the procedure proceeds to the step S53. As the retrieval meta-data at this time, “Display of Fireworks” is stored as “Derived Keyword” as shown in FIG. 7.

In the step S53, whether another personal contents information is selected or not is judged. In case that another personal contents information is selected, the procedure returns to the step S21. In case that another personal contents information is not selected, the meta-data generating processing ends.

In the step S42, in case that the important word does not coincides with the keyword stored in the keyword memory part 36, the procedure proceed to the step S43, and the selection screen of whether the important word is adopted as a keyword or not is displayed on the display 7. In case that the important word is adopted as the keyword, the procedure proceeds from the step S44 to the step S45, the adopted keyword is added as a new keyword to the keyword memory part, the procedure proceeds to the step S46, and the new keyword is temporarily stored in the RAM 4 as a retrieval keyword.

Therefore, the even important word that is not stored in the keyword memory part 36 can be adopted as a keyword according to user's preference, and can be adopted as a retrieval keyword.

Thus, the retrieval meta-data is automatically added to the personal contents information stored in the hard disc drive 5. Hereby, when the personal contents information is retrieved later, in case that the date and time of the personal contents information is not exactly recalled, the retrieval keyword, for example, “Display of Fireworks” in the above case is inputted, whereby the corresponding personal contents information can be exactly retrieved. In this case, it is not necessary for the contents of the personal contents information to coincide with the contents of the keyword described in the retrieval meta-data. In case that the user wants to retrieve the personal contents information picked up about the time of the display of fireworks, the retrieval meta-data that describes the “Display of Fireworks” is added to the personal contents information before and after the display of fireworks. Therefore, with “Display of Fireworks” as the keyword, the personal contents information timely relating to the display of fireworks can be exactly retrieved.

Thus, according to the first embodiment, the text data is collected from the homepage specified by the URL selected by the user, the morphological analysis is performed from this text data to extract the words, and the extracted words and the reference words extracted by performing the morphological analysis from the text data acquired from the homepage specified by another URL stored in advance are subjected to the TFIDF processing of the important word extracting processing. By the TFIDF processing, the words that appear with high frequency in the text data of the homepage according to the user's preference, and the words that appear with low frequency in the homepage of the reference URL are extracted as important words. The word which coincides with the keyword stored in the keyword memory part 36, of the extracted important words is selected as a retrieval keyword. Therefore, the event information characteristic of the provinces can be exactly extracted as the retrieval meta-data, and the retrieval meta-data can be readily generated without requiring the complicated operation. In result, even the user who is unaccustomed to the operation can add the retrieval meta-data to the personal contents information readily.

Further, since the user can select the contents information for which the retrieval meta-data is to be created, the keyword most suited to the user himself can be extracted. Therefore, as the keyword when the personal contents information is retrieved later, the most suitable keyword can be set.

Further, the keyword that coincides with the keyword stored in the keyword memory part, of the important words extracted by the keyword selection processing is set as the retrieval keyword. Therefore, since the many keywords are not thoughtlessly set as the retrieval keywords, only the keyword necessary for the user is set as retrieval meta-data, and the whole number of retrieval meta-data can be limited.

In the first embodiment, though the case in which the homepage of the news site of the local newspaper and the homepage of the news site of the nationwide newspaper are selected has been described, the invention is not limited to this. The URL specified by the user and the reference URL that is compared in order to eliminate the average words from the specified URL can be set arbitrarily.

Further, in case that there are a reception electronic mail relating to the personal contents information and other reception electronic mails, these electronic mails may be selected.

In the first embodiment, though the case in which the URL is specified has been described, the invention is not limited to this. By means of not only the Internet but also other networks, contents information that becomes base data for generating the retrieval meta-data may be available.

Further, in the first embodiment, though the case in which the important word is extracted from the text data has been described, the invention is not limited to this. For example, in word extraction processing, from the text data of the homepage, a word of a big font, and a word that adopts an italic font or a bold font may be extracted as the important words.

Next, a second embodiment of the invention will be described with referent to FIGS. 8 to 14.

In this second embodiment, contents information is acquired from a printing on which sentences are printed in place of a homepage.

In this second embodiment, as shown in FIG. 8, a color image scanner 17 is connected through a scanner connection interface part 18 to a system bus 2, and image data of a printing loaded by the color image scanner 17 is loaded by a central processing unit 1 thereby to be character-recognized, whereby important words are extracted.

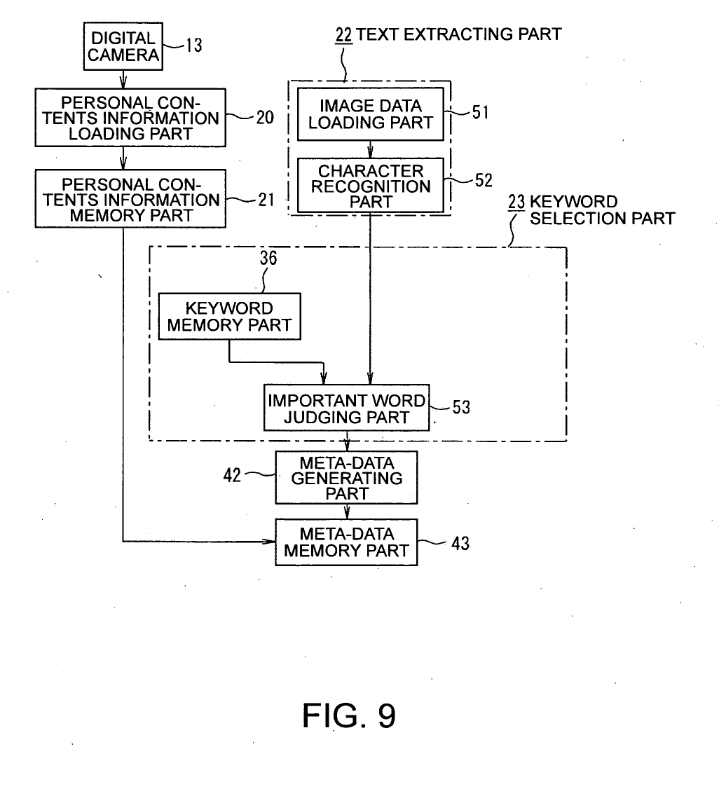

A function block diagram of the central processing unit 1 in FIG. 9 has the similar structure as the structure in FIG. 2 except that: a text extracting part 22 includes an image data loading part 51 which loads image data from the color image scanner 17, and a character recognition part 52 which character recognizes a character in the specified area from the image data loaded by this image data loading part 51; and a keyword selection part 23 includes a keyword memory part 36, and an important word judging part 53 which compares the word input from the character recognition part 52 with the keyword stored in the keyword memory part 36, and judges, in case that the both words coincide with each other, their words to be important words. Parts corresponding to those in FIG. 2 are denoted by the same reference numerals, and their detailed description is omitted.

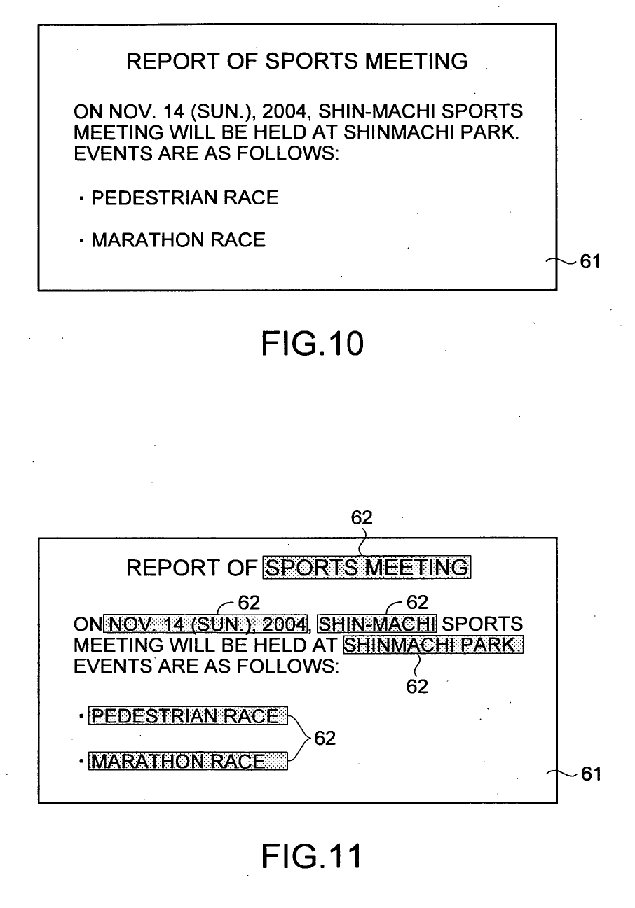

In this second embodiment, as shown in FIG. 10, there is prepared a printing 61 in which a sentence relating to personal contents information picked up by the user is written in black on white paper, such as a newspaper, a leaflet, or a report distributed from a school. In the sentences described in this printing 61, words which the user wants to use as retrieval meta-data are denoted by an area identification mark 62 as shown by a hatching area in FIG. 11. The area identification mark 62 indicates a red extraction word area capable of reading the sentence.

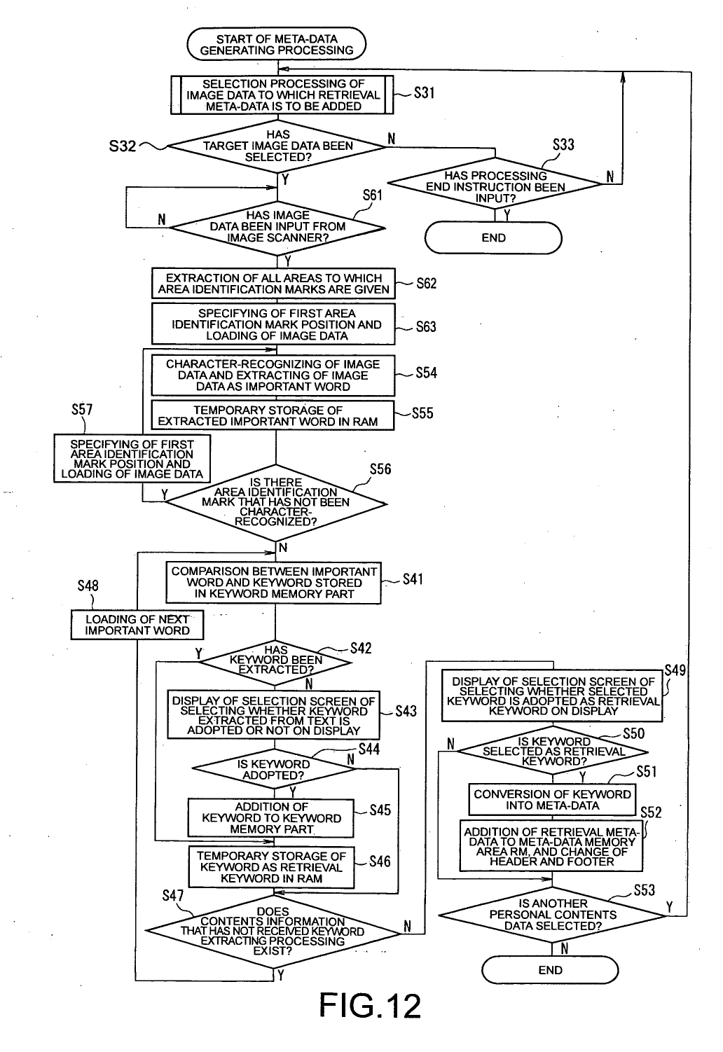

Namely, in the second embodiment, in the center processing unit 1, meta-data generating processing in FIG. 12 is executed.

In this meta-data generating processing, the steps S34 to S41 in FIG. 6 in the first embodiment are omitted. Alternatively, when the judgment in the step S32 results in the selection of targeted image data, the procedure proceeds to a step S51. In the step S51, whether the image data has been inputted from the color image scanner 17 or not is judged. When the image data has not been inputted, the procedure waits till this data is inputted. When the image data has been inputted, the procedure proceeds to a step S52.

In this step S52, all the areas denoted by the area identification mark 62 are extracted, and the procedure proceeds to a step S53. In the step S53, a leading area of the extracted areas is specified, image data in its area is loaded, and the procedure proceeds to a step S54. In the step S54, character-recognition processing of character-recognizing the loaded image data and extracting its data as an important word is performed, and the procedure proceeds to a step S55. In the step S55, the extracted important word is stored in the predetermined memory area of a RAM 4 and the procedure proceeds to a step S56.

In this step S56, whether the area identification mark 62 that has not been character-recognized exists or not is judged. In case that the area identification mark 62 that has not been character-recognized exists, the procedure proceeds to a step S57. In the step S57, the area identification mark 62 area to be next identified is specified, image data in its area is loaded, and the procedure returns to the step S54. When the area identification mark 62 that has not been character-recognized does not exist, the procedure proceeds to the step S41 in FIG. 6 in the first embodiment.

According to this second embodiment, a user goes to a sports meeting, takes a photograph by means of the digital camera 13, stores image data in a memory card, goes back to his home, and connects the digital camera 13 to an information processing apparatus PC through a digital camera connection interface part 14, or pulls out the memory card from the digital camera 13 to attach the pulled memory card to a memory card reader 15, whereby the personal contents information loading processing shown in FIG. 3 is executed similarly to the case in the first embodiment, and the image data and pick-up meta-data are stored in the image data memory area formed in the hard disc 5.

Thereafter, an icon displayed on the display 7, which represents meta-data generating processing is selected, whereby the meta-data generating processing show in FIG. 12 is executed, and the image data to which retrieval meta-data is to be added is selected.

Thereafter or previously, in the printing 61 shown in FIG. 10 on which the sentence relating to the picked-up personal contents information is written, the red area identification mark 62 is given to the words which the user wants to extract as shown in FIG. 11. Next, the printing 61 is set in the color image scanner 17, and scanned to form image data. This image data is inputted through the image scanner connection interface part 18 to the central processing unit 1.

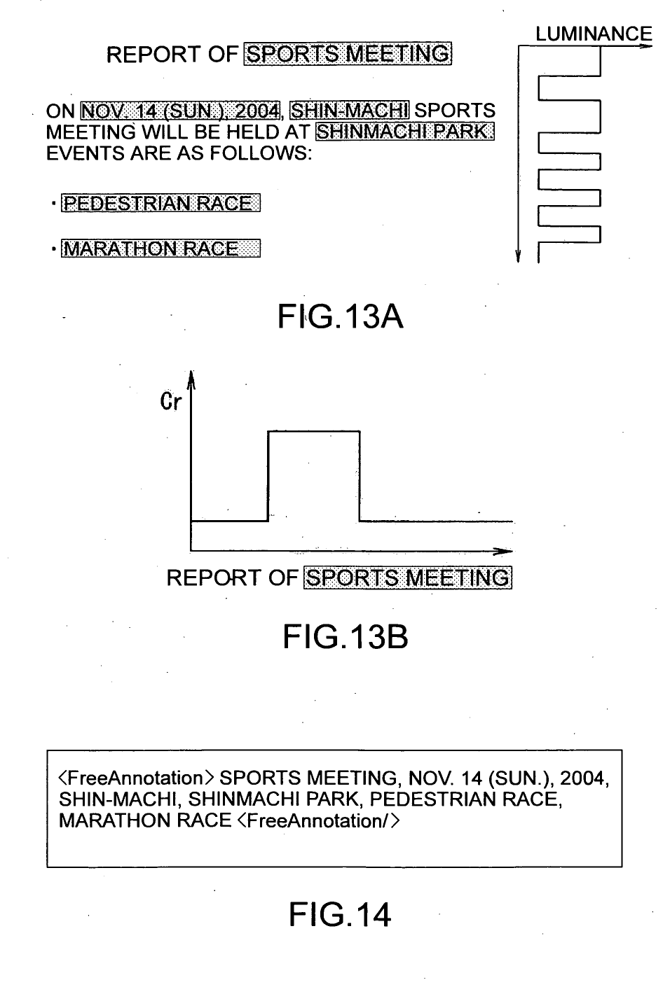

At this time, in the meta-data generating processing in FIG. 12, upon reception of input of the image data from the color image scanner 17, the area identification mark 62 is detected from this image data, and an area in which character recognition is performed is cut out. In area cutting at this time, the image data is scanned in the lateral direction as shown in FIG. 13A, a character area in which a character that is low in luminance is printed is detected, and an area indicating red color data is detected as shown in FIG. 13B. The area position to which the area identification mark 62 is given is specified from both detection areas, and the character area to which this area identification mark 62 is given is extracted.

Next, in the leading character area to which the area identification mark 62 is given, the image data is loaded to perform character-recognition processing. For example, “Sports Meeting” in a title in FIG. 10 is converted into text data and temporarily stored in the RAM 4 as an important-word. Next, the next area to which the area identification mark 62 is given is specified, and “Nov. 14 (Sun), 2004” is converted into text data and temporarily stored in the RAM 4 as an important word. Sequentially “Shin-machi”, “Shin-machi Park”, “Pedestrian race”, and “Marathon race” are temporarily stored in the RAM 4 as important words.

Thereafter, the important words are compared with the keywords stored in the keyword memory part 36, and the important words stored as the keywords are adopted as retrieval keywords. When the adopted retrieval keywords are selected as keywords, the retrieval keywords are converted into meta-data. Hereby, retrieval meta-data shown in FIG. 14 is generated, the converted retrieval meta-data is added to the meta-data memory area RM in the image data memory area, and thereafter a header and a footer are changed.

According to this second embodiment, the user specifies the printing 61 on which the sentence that he desires as the retrieval meta-data is written, gives the area identification mark 62 to the words which he wants to extract from this printing 61, and thereafter sets the printing 61 in the color image scanner 17. When scanning starts, the image data of the printing 61 is formed and inputted into the information processing apparatus PC. In the meta-data generating processing, the image data picked up by the digital camera 13 is selected and thereafter the image data is imported from the image scanner 17. Hereby, the image data in the areas to which the area identification mark 62 is given are character-recognized and extracted as the important words, and the important word that coincides with the keyword stored in the keyword memory part 36, of the extracted important words is selected as the retrieval keyword. The selected retrieval keyword is converted into the retrieval meta-data and added to the image data of the personal contents information. Therefore, the retrieval meta-data necessary for the user can be exactly generated and added to the image data.

In the second embodiment, though the case in which the red display is performed as the area identification mark has been described, the invention is not limited to this. Arbitrary color display may be performed as long as the character can be recognized by its color display. Further, in place of color display, underline display or frame display can be applied.

Further, in the above embodiment, the case in which the printing 61 to which the area identification mark 62 is given is loaded as the image data by the color image scanner 17 has been described. However, the invention is not limited to this. For example, without giving the area identification mark 62 to the printing 61, the image data is loaded by the image scanner, this image data is character-recognized and converted into the text data, this text data is displayed on the display 17, and from the displayed text data, the important words may be extracted using a keyboard or a mouse.

The entire disclosure of Japanese Patent

Application No. 2005-013693, filed Jan. 21, 2005 is expressly incorporated by reference herein.

What is claimed is:

1. A meta-data generating apparatus comprising:
a personal contents information loading unit which loads personal contents information,
a text extracting unit which extracts text from other contents information relating to the personal contents information loaded by the personal contents information loading unit, and
a meta-data generating unit which generates, on the basis of the text extracted by the text extracting unit, retrieval meta-data for the personal contents information loaded by the personal contents information loading unit.

2. The meta-data generating apparatus according to claim 1, wherein the meta-data generating unit includes a keyword selection unit which selects a keyword from the text extracted by the text extracting unit; and the meta-data generating unit, on the basis of the keyword selected by the keyword selection unit, generates the retrieval meta-data for the personal contents information loaded by the personal contents information loading unit.

3. The meta-data generating apparatus according to claim 2, wherein the keyword selection unit is so constituted as to select characteristic character data in the text as a keyword.

4. The meta-data generating apparatus according to claim 3, wherein the character data has a characteristic font, compared with other character data included in the text.

5. The meta-data generating apparatus according to claim 2, wherein the keyword selection unit has a word division unit which divides text data into words and extracts the words; and the keyword selection unit selects as the keyword the word selected on the basis of information of parts of speech of the words extracted by the word division unit.

6. The meta-data generating apparatus according to claim 2, wherein the keyword selection unit includes a keyword memory unit that stores the predetermined keyword, and selects, from the text extracted by the text extracting unit, a word that coincides with the keyword stored in the keyword memory unit, as a keyword.

7. The meta-data generating apparatus according to claim 6, wherein the keyword memory unit updates the stored keyword by means of any one or a plurality of digital broadcasting radio waves, a network, and a memory medium.

8. The meta-data generating apparatus according to claim 1, wherein the text extracting unit includes at least an image reading unit which reads a printing on which text is printed, an area identification unit which identifies a specified area from the image data read by the image reading unit, and a character recognition unit which character-recognizes the image data in the specified area identified by the area identification unit.

9. The meta-data generating apparatus according to claim 1, wherein the text extracting unit includes at least an image reading unit which reads a printing on which text is printed, a character recognition unit which character-recognizes the image data read by the image reading unit, and a word division unit which divides the characters recognized by the character recognition unit into words and extracts the words.

10. The meta-data generating apparatus according to claim 1, wherein the text extracting unit includes at least an image reading unit which reads a printing on which text is printed, an area identification unit which identifies a specified area from the image data read by the image reading unit, a character recognition unit which character-recognizes the image data in the specified area identified by the area identification unit, and a word division unit which divides the characters recognized by the character recognition unit into words and extracts the words.

11. The meta-data generating apparatus according to claim 1, wherein the text extracting unit includes at least a contents information collection unit which collects contents information through a network from contents information providing means, and a word division unit which extracts text from the contents information collected by the contents information collection unit and divides the extracted text into words to extract the words.

12. The meta-data generating apparatus according to claim 11, wherein the keyword selection unit includes a comparison contents information collection unit which collects comparison contents information from other plural contents information providing means than the contents information providing means of the text extracting unit; a word division unit which divides the contents information collected by the comparison contents information collection unit into words and extracts comparison words; and an important word judging unit which compares the comparison words extracted by the word division unit with the texts inputted from the text extracting unit, and judges whether the words inputted from the text extracting unit are important words as keywords.

13. The meta-data generating apparatus according to claim 12, wherein the important word judging unit judges the word which is inputted from the text extracting unit and high in appearance frequency, and the comparison word which is low in appearance frequency to be important words, and extracts these words as keywords.
